(19) United States
(12) Patent Application Publication
(10) Pub. No.: US 2002/0075851 A1
(43) Pub. Date: Jun. 20, 2002

(54) Terminal of a packet-switching communications network and method for operating a telecommunications system having a packet-switching communications network

(76) Inventors: Thomas Brumm, Gauting-Koenigswiesen (DE); Udo Klotz, Neuried (DE); Norbert Loebig, Darmstadt (DE); Walter Zinkl, Wien (DE); Patrick Kleiner, Muenchen (DE); Robert Kresnik, Slovenska Bistrica (SI); Irena Romanski, Egling (DE)

Correspondence Address: BELL, BOYD & LLOYD, LLC, P. O. BOX 1135, CHICAGO, IL, 60690-1135, US

(21) Appl. No.: 09/827,485

(22) Filed: Apr. 6, 2001

(30) Foreign Application Priority Data
Apr. 6, 2000 (DE) 10017226.1

(51) Int. Cl. H04L 12/66; H04J 3/16

(52) U.S. Cl. 370/352; 370/465; 370/522

(57) ABSTRACT

Terminal of a packet-switching communications network and method for operating a telecommunications system of a packet-switching communications network wherein the terminal contains a data processing system which has, in addition to its operating system, a program module for processing signaling information of a packet-switching communications network, the terminal is connected to the packet-switching communications network via a subscriber line and the program module processes further signaling information which is transmitted using the packet-switching communications network.

### BACKGROUND OF THE INVENTION

1. Field of the Invention

The present invention relates to a terminal for connection to a packet-switching communications network and a method for operating a telecommunications system having a packet-switching communications network. The terminal contains a data processing system and is connected to a subscriber line of a packet-switching communications network. The packet-switching communications network is used to transmit data between the terminal and the packet-switching communications network.

2. Description of the Prior Art

There are various types of communications networks for transmitting voice, video data and further data. Different services and features have been developed for each of these communications networks by virtue of the various ways in which these communications networks can be used. Conventional communications networks for the transmission of voice are generally line-switching communications networks and communications networks for transmitting other data are usually packet-switching communications networks; for example, a local computer network (Local Area Network; LAN) or the Internet. However, at present voice, data and video services of both types of communications network can be made available. It is therefore possible, for example, to connect a subscriber to the line-switching communications network via a packet-switching communications network. Supplementary services such as call pick-up, three-way conferencing, large-scale conferencing, holding, displaying of toll information, closed user group, call number identification, automatic call-back when busy, automatic call-back when no response, call barring, call waiting indication and call transfer which are made available in known line-switching communications networks can, to a certain extent, be used in packet-switching communications networks. Standards, for example in the series of the Recommendations of the International Telecommunication Union Telecommunications Standardization Sector (ITU-T Recommendation) based on the H.323 are defined for packet-switching communications networks. These standards include, in particular, the standards H.323, H.225 and H.450.

An H.323 architecture for supplementary services in which there is a possibility of interaction of the services between line-switching and packet-switching communications networks is also known. For example, it is known that user-channel-related signaling messages for activating, deactivating, requesting and controlling services and performance of the features in the line-switching communications network are mapped onto signaling packets which are used in the packet-switching communications network. Preferably, what are known as DSS1 messages which are defined in the ITU Standards Q.931 and Q.932 are used in the line-switching communications network. Preferably the standardized H.225 signaling protocol is used for transmitting the signaling packets in the packet-switching communications network; in particular, in the Internet. Services and features which to be used require user-channel-related signaling messages are, for example, call pick-up, three-way conferencing and large-scale conferencing, holding, displaying of toll information, closed user group and call number identification services. Signaling which is independent of a user connection or a user channel is necessary for status interrogations and for activating or deactivating service features; for example, call divert, automatic call-back when busy, automatic call-back when no response and call waiting indication.

Components such as terminals, gateways and gatekeepers are provided and defined for transmitting voice according to the H.323 Standard. Terminals are terminating devices which are connected to the packet-switching communications network. In packet-switching communications networks it is necessary for the subscriber to register or log on with his terminal. A gateway is used as an interface for converting the data protocols between the packet-switching communications network and line-switching communications network. A gatekeeper is used to administer and to check user services and network capacities of a packet-switching communications network according to the H.323 Standard. The addressing of an incoming call also takes place in the gatekeeper in the packet-switching communications network. Each subscriber has an address in the packet-switching communications network. The telephone number which is selected by a calling subscriber is converted by the gatekeeper to the address of the subscriber in the packet-switching communications network. In this way, the H.323 Standard can be used to transmit telephone calls in the Internet and in networks based on an Internet protocol.

Large packet-switching networks provide the possibility of enabling a number of employees who do not work in the same office, or do not work in the same office continuously, to use common functions on the network. This is sensible, in particular, if employees have to travel often or work as teleworkers at home. These employees are then connected to an external data network, for example the Internet. This Internet then provides these employees with access to the internal data network of the company; for example, an Intranet and to the telecommunications network, e.g. the work network of the company. Employees who work, for example for a department, or on a project are combined into groups, which are known as CENTREX groups, in particular for the sake of better accessibility. CENTREX is a special service which is made available using a network node of a telecommunications network. CENTREX can be used to provide some of the connected subscribers, for example the employees of the department or of the project, with a range of functions corresponding approximately to the range of functions of a private branch exchange, even though they are not all connected to the same private branch exchange. Using the CENTREX service it is possible, for example, for an incoming call for one employee in the group also to be made visible and available to other preset subscribers. Thus, with the CENTREX service there is also the possibility of presetting a team call or a call transfer. Here, when there is an incoming call to a subscriber line in the group a message is generated which is transmitted to the other subscriber lines which are preset in this group. Each subscriber of the group can then receive this call. Each of the subscribers in the group can also receive calls parked in the system. The subscribers of the CENTREX group can also have a common call number schedule which can be used by all the subscriber lines. However, with the prior art, it is possible to use the CENTREX service and other services known on voice connections, such as three-way conferencing, call forwarding, call transfer, subscriber cut-in, recorded announcement services and private call number schedule only in a line-switching communications network. According to the H.323/H.450 Standard, these services are not supported for voice connections using the packet-switching communications network, or not to the same extent.

An object of the present invention is to disclose a terminal for connection to a packet-switching communications network, and a method for operating such a terminal, which provides a subscriber not only with the services and features of the packet-switching communications network but also with further services and features.

### SUMMARY OF THE INVENTION

The object is achieved for a terminal for connection to a packet-switching communications network, and for a method for operating a terminal in a packet-switching communications network, wherein particular, the processing of further signaling information enables a subscriber to be provided with further services and/or features which are not supported by the packet-switching communications network per se. This signaling information can be transmitted to a further subscriber line of the packet-switching communications network or to a further communications network. The further communications network, for example a public telecommunications network, can use the signaling information to make available further services and/or features to the terminal connected to the packet-switching communications network. In this way, in particular services and features can also be made available to subscriber lines of the packet-switching communications network which can be used on a standard basis in known line-switching communications networks. As a result, the subscriber of the packet-switching communications network no longer has to dispense with services and/or features which are automatically made available to subscribers of a line-switching communications network. The subscriber can continue to use the services and features of the packet-switching communications network without restriction.

In one advantageous embodiment, the terminal contains a display unit for displaying data and an input unit for inputting data, a second program module of the data processing system converting the transmitted signaling information into image information to be displayed on the display unit, and processing information which is input using the input unit. This ensures that the inputs which are necessary to control the services and/or features and outputs for the subscriber which are made necessary by these services and/or features are possible in a convenient way. Separating the program module for processing the signaling information and the second program module for converting the signaling information into image information and for processing the information input using the input unit makes it possible to display image information and acquire input information independently of the processing of the signaling information. The signaling information can, thus, be used in a flexible way by a number of program modules of the data processing system. The program module for processing the signaling information does not need to be adapted for this purpose. In this way, various, user-specific user interfaces, which can be switched over using the second program module, can be designed for various users of the data processing system. Furthermore, it is possible for each user to have his/her own second program module processed in that a user interface which is adapted for him/her is preset with specific operator functions.

In one embodiment of the present invention, the information acquired using the second program module is conditioned using the program module for processing signaling information for transmission through the packet-switching communications network. In this way, the inputs also can be used to control, activate, deactivate and/or administer services and/or features which are not supported by the packet-switching communications network per se. The first program module converts the input data into signaling information of the packet-switching communications network and to further signaling information which is transmitted using the packet-switching communications network. All the signaling information generated by the first program module is transmitted to a further subscriber line of the packet-switching communications network, to a subscriber line of a line-switching communications network which is connected to the packet-switching communications network and/or to a signaling system of a further packet-switching communications network or of a line-switching communications network.

It is advantageous here if the program module processes signaling data in accordance with an H.323/H.450 signaling protocol, a DSS1 signaling protocol, a QSIG signaling protocol and/or a CORNET NC signaling protocol. This ensures that the program module processes signaling data in accordance with standardized signaling protocols which are widespread. In this way, further signaling information for services and/or features which are not supported by the H.323/H.450 Standard can be generated and further processed in accordance with the DSS1 signaling protocol in a packet-switching communications network with a signaling protocol in accordance with the H.323/H.450 Standard.

The DSS1 signaling protocol is widespread in public telecommunications networks. This further DSS1 signaling information can be transmitted using predetermined data packets in the packet-switching communications network and fed to a further subscriber line of the packet-switching communications network. The DSS1 signaling information also can, however, be fed to a line-switching communications network and control corresponding services and/or features in the network. Here, the signaling data is preferably used for connection setup, for connection release and/or for controlling at least one service and/or feature. Such a service and/or feature includes call pick-up, three-way conferencing, large-scale conferencing, holding, displaying of toll information, a closed user group, call number identification, automatic call back when busy, automatic call back when no response, call barring, call waiting indication and/or call transfer. As a result, services and/or features which are customary in line-switching communications networks are made available, as a result of which subscribers of the packet-switching communications network can, for example, easily make voice connections with a high degree of convenience.

In another embodiment of the present invention, the further signaling information is transmitted as data using the packet-switching communications network. This data can be transmitted, for example, as user data using the packet-switching communications network. This ensures that sufficient transmission capacity is available for the transmission of the further signaling information.

According to another embodiment, the further signaling information also can be transmitted as data in a data packet with signaling information of the packet-switching communications network. As a result, the further signaling information also can be transmitted using the data packets for signaling control which are provided in the packet-switching communications network. Additional signaling connections and the processing of additional data packets by the signaling system of the packet-switching communications network and by the program module of the data processing system are not necessary in this embodiment.

In another embodiment of the present invention, the data processing system contains a third program module which processes the further signaling information transmitted as data. As a result, during the processing of the signaling information it is possible to separate, in the data processing system, the processing of signaling information which is supported by the signaling system of the packet-switching communications network and further signaling information for controlling further services and/or features. This separation makes possible a simple and clearly organized program structure in the data processing system. The adaptation and the implementation of new features is also possible in an easy and clearly organized way.

In another advantageous embodiment, the further signaling information is transmitted to a further subscriber or to a further communications network in accordance with a tunnel principle in which the signaling information is transmitted as data between the two subscribers. In this way, signaling can be carried out between the further subscriber line or a further communications network and the subscriber without the signaling information having to be transmitted using signaling data of the packet-switching communications network.

In another advantageous embodiment of the present invention, the signaling information which is processed by the program modules of the data processing system and the further signaling information is stored in a database of the data processing system. The signaling information to be processed by the program modules also can also be stored in this database. Such a database can be used to make access by the program modules of the data processing system to the signaling information easily possible. As a result of the clearly organized structure of databases, errors during the processing of signaling information can be analyzed and avoided. Furthermore, the exchange of data between the individual program modules of the data processing system is possible using such a database.

It is also advantageous if the terminal makes available a graphic user interface which can be adapted by a user of the terminal to his requirements, using a fifth program module. As a result, it is possible for the operating convenience of the terminal to be adapted easily to the requirements of the respective user. For a number of users it is possible here to store different user interfaces which can be switched over using, for example, the second program module.

It is also advantageous here if the graphic user interface has displayed buttons which can be operated using a pointer device or a touch screen. As a result, a simple and intuitive operating facility is provided, the operating convenience capable of being easily adapted to the requirements of the respective user. The intuitive control can be improved by a suitable, freely selectable arrangement of the displayed buttons. As a user interface it is possible to present, for example, a conventional telephone with the key elements of a telephone, the keys having the same functions as in the illustrated conventional telephone. A terminal according to the present invention can be connected as a so-called IP terminal to a data network, for example to the Internet, which is based on an Internet protocol. The increasingly widespread prevalence of data networks which are based on an Internet protocol makes it increasingly desirable to make use of these data networks also for conventional telecommunications. The terminal according to the present invention permits the data network to be used for conventional telecommunications and ensures a high level of operating convenience as well as high quality service.

In one advantageous embodiment, the terminal is a computer system with software and hardware. In particular, modem personal computers which are operated on data networks can be used as the terminal according to the invention.

In a method for operating a terminal in a packet-switching communications network of the present invention, it is possible for a subscriber also to be provided with services and features of conventional telecommunications networks using a subscriber line of a packet-switching communications network.

Additional features and advantages of the present invention are described in, and will be apparent from, the following detailed description of the preferred embodiments and the drawings.

### BRIEF DESCRIPTION OF THE FIGURES

FIG. 1 shows the basic software structure of a terminal according to the present invention.

FIG. 2 shows an IP network which is connected to a public telephone network, a conventional terminal for IP networks and a terminal according to the present invention.

FIG. 3 shows an example of a graphic user interface which is displayed on a display unit of the terminal according to the present invention.

FIG. 4 shows a further example of a graphic user interface to be displayed using the terminal according to the present invention.

### DETAILED DESCRIPTION OF THE PREFERRED EMBODIMENTS

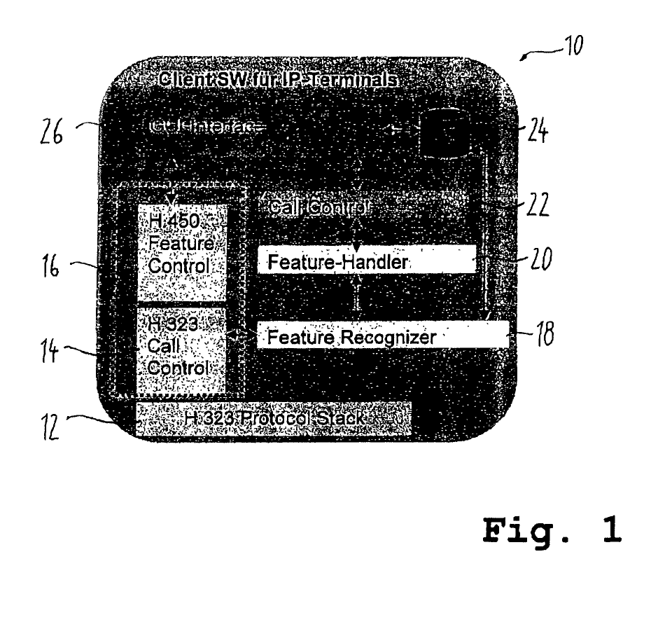

FIG. 1 illustrates the basic structure of the software of a terminal according to the present invention for connection to a subscriber access of a packet-switching communications network. The packet-switching communications network is preferably based on an Internet protocol and is also referred to as an IP network. As already explained in the introduction to the description, it is customary in IP networks to use signaling in accordance with the H.323/H.450 Standard for conventional telecommunications; for example, for voice connections. The H.323 Standard includes primarily the connection controller, and the H.₄₅₀ Standard includes primarily the controller, activation and deactivation processes as well as the administration of services and features. The signaling information is transmitted via the IP network using signaling packets. The H.323/H.450 signaling information and further signaling information in accordance with the method according to the present invention is transmitted to the terminal using these signaling packets. The further signaling information is used to control further services and/or features which are not supported by the H.323/H.450 Standard. Such a further service and/or feature may include call pick-up, three-way conferencing, large-scale conferencing, holding, displaying of toll information, a closed user group, call number identification, automatic call back when busy, automatic call back when no response, call barring, call waiting indication and/or call transfer.

The signaling packets which are transmitted to the subscriber line of the terminal are fed to an H.323 protocol stack 12. A H.323 connection controller 14 processes the received signaling packets and carries out connection control in accordance with the H.323/H.450 signaling information. The connection controller 14 transfers the signaling information, which relates to the H.450 services and/or features, to a H.450 program module for controlling services and/or features of the IP network. The H.323 connection control program 14 transfers the data which does not relate to the H.323/H.450 signaling to an evaluation program 18 which evaluates the further signaling information contained in this data. The evaluation program 18 transfers the signaling information obtained to a service feature and feature control program 20 which makes available the appropriate services and features using the further signaling information.

The control program 20 also generates acknowledgements and/or further signaling information which are used to control the corresponding services and/or features. A second connection control program 22 is used for connection control which is necessary, in particular, for the services and features which are made available by the control program 20. The evaluation program 18 receives, from the H.323 connection control program 14, not only the further signaling information but also the H.323 signaling information. The evaluation program 18 transmits all the signaling information to a database 24. A display program 26 for controlling a graphic user interface is connected to the H.450 program module for controlling services and/or features and to the connection controller 22 and to the database 24. Status information and control information of the H.450 services and/or features are transferred to the display program 26 by the H.450 program module 16. The connection controller 22 transmits information relating to the control of the further services and/or features to the display program module 26. Furthermore, the display program module 26 has access to the database 24. User-specific settings of the graphic user interface, which are used by the display program module 26 to actuate the graphic user interface, are also stored in the database 24.

The further signaling information may be used as, for example, signaling in accordance with the DSS1 standard, as a result of which all the services and/or features of conventional telecommunications networks are made available to the terminal. The method of displaying the relevant information and the quantity of displayed information can be preset and configured here using the display program module 26. If such a terminal is used by a number of users, different user interfaces can be configured, it being possible to configure different user profiles with different rights of use in the database 24. The display program 26 for controlling the user interface is logically separated from the program modules 12, 14, 16, 18, 20, 22 for processing signaling information. As a result of this separation, the user interface can be freely configured using the program module 26.

In another exemplary embodiment, the exchange of data is not carried out exclusively using the database 24. Data is exchanged between the program 26 for controlling the user interface and the program modules 16, 22 and the database 24 using a program interface. This program interface is used to define various data fields for exchanging data, for example display field for call numbers, keypad and abbreviated dialing keys. The displaying of this data then can be defined individually using the display program 26 for the individual data and generated itself by a suitable processing program. The data to be displayed using the user interface and the display format and the representation of the data are also stored in the database 24. A number of user profiles which can be preset in the database can be used to configure a number of user interfaces between which a user can select a type of representation which is suitable for him/her. User interfaces which have been configured by different users also can be stored in the database 24 and switched over using, for example, input fields or buttons of the user interface with the result that a user can at any time conveniently set and use a user interface preconfigured by him/her. This switching over of the user interface is also possible when there is an existing connection to another subscriber.

With such a terminal, a subscriber can not only use H.323 and H.450 services and/or features without restriction but also services and/or features which are otherwise available to him/her only in conventional telecommunications networks. The subscriber can, thus, use private call number schedules and the associated features which are available to him on another subscriber line. The subscriber can also form what is known as a CENTREX group with other subscribers of the IP network and/or a conventional telecommunications network connected to this IP network. In a CENTREX group, a number of subscribers are combined to form a group and they are provided with specific functions, for example a common call number schedule, call waiting indication and call pick-up, it being possible for the subscribers of the CENTREX group to be connected to any desired subscriber lines of the communications network. The terminal can also set up connections to terminals which support only H.323/H.450 signaling. It is not necessary to perform any changes to the software or hardware of the terminal according to the present invention to do this. The terminal also can be operated in a line-switching communications network, in which case only DSS1 signaling information is then available. As a result, the terminal according to the present invention also can be connected to what is known as a terminal adapter which is connected between the terminal according to the present invention and the IP network and which converts the signaling data of the IP network into DSS1 signaling information and feeds it to the terminal.

Furthermore, it is easily possible to agree and add new service features and features which can then be used with the terminal according to the invention. The signaling data for making available and/or using these new services and features are simply transmitted as further signaling data.

Other terminals of the same type also can be used with other signaling protocols; such as the QSIG and the CORNET NC signaling protocol. The freedom of design of the user interface also makes it possible to implement specific customer requirements such as the representation of company logos, advertising or the use of specific colors with little complexity. The further signaling information can be transmitted using, for example, the H.323 signaling packets. However, it is also possible to transmit the further signaling information, or at least a portion of the further signaling information, using separate data packets of the IP network. In the case of service features and/or features which can be carried out both using the H.323/H.450 signaling information and with the further signaling information, the H.323/H.450 signaling information is primarily used in the present exemplary embodiment. The further signaling information, for example the DSS1 signaling information of the same feature, is not processed further in order to avoid reactions between identical features.

The evaluation program 18 analyzes and processes the further signaling information which has been transmitted using the IP network. This further signaling information includes, for example, DSS1 signaling information. The evaluation program 18 analyzes the signaling information and compares it with the subscriber profile stored in the database 24. If the stored subscriber profile supports the service and/or feature controlled by the signaling information, the signaling information is transferred to the control program 20 for the implementation of the respective service and/or feature. Together with the connection controller 22, the control program 20 carries out the corresponding service and/or feature together with the respective call.

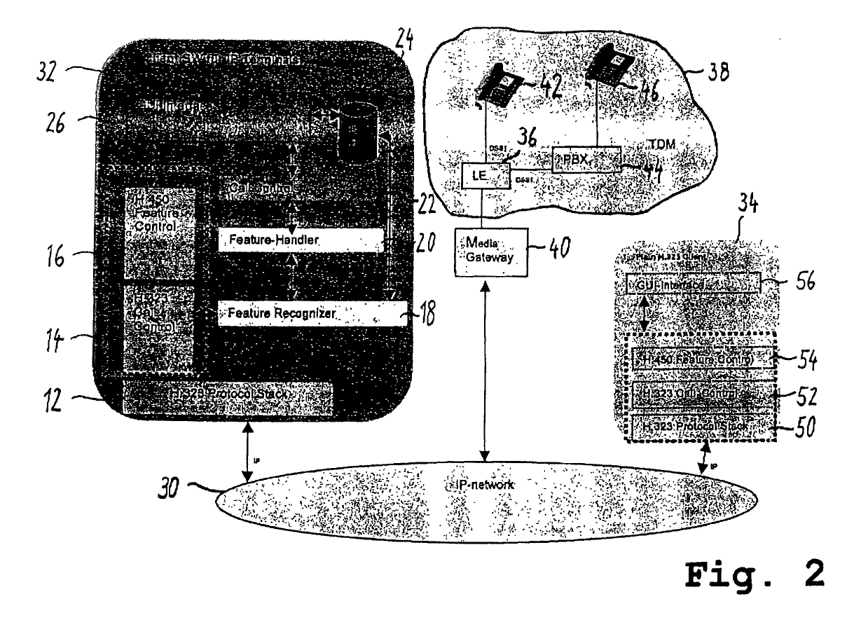

FIG. 2 illustrates a network which is based on an Internet protocol, the IP network 30, to which a terminal 32 according to the present invention, a conventional terminal 34, which is suitable for a connection to an IP network, and a switching center 36 of a line-switching communications network 38 are connected, the line-switching communications network being connected to the IP network 30 using a media gateway 40. A terminal 42 and a private branch exchange 44 are connected to the switching center 36, to a subscriber line of the switching center. The signaling of the private branch exchange 44 and of the terminal 42 is carried out using DSS1 signaling information. Communications terminals, of which one communications terminal 46 is illustrated, can be connected to the private branch exchange 44. The signaling between the private branch exchange 44 and the terminal 46 is also carried out using DSS1 signaling information.

When there is a connection setup between the terminal 42 and the terminal 32, the DSS1 signaling information is transmitted from the terminal 42 to the media gateway 40 using the switching center 36. The media gateway 40 converts the DSS1 signaling information into H.323/H.450 signaling information. DSS1 signaling information which cannot be converted into H.323/H.450 signaling information is transmitted to the terminal 32 via the IP network 30 as DSS1 signaling information in a separate data area of the H.323/H.450 signaling packet. The program modules of the terminal 32 are used to evaluate, condition and process the H.323/H.450 signaling information and the DSS1 signaling information as already described in FIG. 1, with the result that the information can be displayed to the user of the terminal 32 using a graphic user interface. The terminal 32 also generates H.323/H.450 signaling information in order to control the connection to the terminal 42, said signaling information being transmitted via the IP network 30 to the media gateway 40 using the signaling packets.

In order to control services and features which are not supported by the H.323/H.450 signaling protocol, the terminal 32 additionally generates DSS1 signaling information. This DSS1 signaling information is included in the transmission in the already mentioned data area of the signaling packets to the media gateway 40. The media gateway 40 converts the H.323/H.450 signaling information into DSS1 signaling information and feeds it to the switching center 36, at least some of the information being forwarded to the terminal 42. The DSS1 signaling information which is transmitted in the data area of the signaling packet is also fed to the signaling system of the switching center 36 using the media gateway 40. Via the transmission of DSS1 signaling information via the IP network 30 to the media gateway 40, it is also possible to make use of features which are connection-independent; for example, call back when busy.

The terminal 34 is, like the terminal 32, an IP terminal and has a H.323 protocol stack 50, a H.323 connection controller 52 and a H.450 program module 54 for controlling services and/or features. The terminal 34 is a known terminal for voice connections via IP networks 30. The connection controller between the terminal 34 and the terminal 32 is made using H.323/H.450 signaling information. DSS1 signaling information is not used for such a connection because it is not supported by the terminal 34.

If a connection is made between the terminal 32 according to the present invention and a further terminal of the same type which is also connected to the IP network 30, both H.323/H.450 signaling information and DSS1 signaling information can be used for signaling between the two terminals.

The terminal 32 also can transmit to the terminal 34 DSS1 signaling information which is, however, not processed by the terminal 34. The features which are to be implemented using the DSS1 signaling information are then not available for the connection between the terminal 32 and the terminal 34.

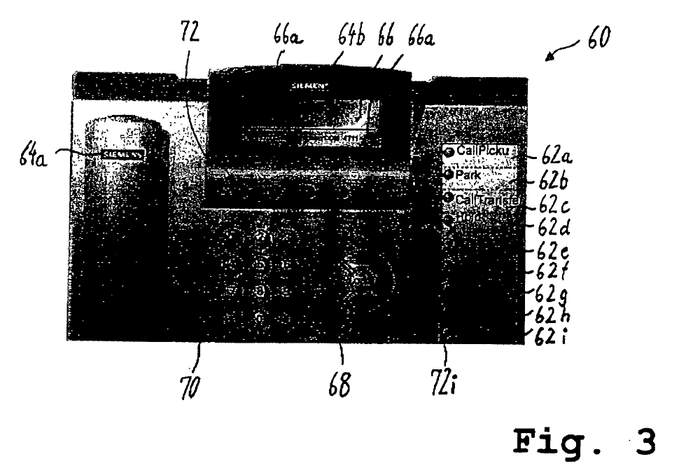

FIG. 3 illustrates a possible user interface 60 of the terminal 32. This user interface 60 is displayed, for example, on the screen of a personal computer. A representation of a real, conventional telephone is used as a user interface 60. The user interface 60 contains abbreviated dialing keys 62a to 62i to which functions such as call pick-up 62a, parking of calls 62b, call divert 62c and holding of messages 62d are assigned. Further abbreviated dialing keys 62e to 62i can be assigned call numbers of subscribers or further functions. The abbreviated dialing keys 62a to 62i are embodied as buttons of the user interface and can be activated using, for example, a pointer apparatus such as a computer mouse. As a result, either the information stored using the abbreviated dialing key is activated or a stored call number is selected for a connection set up. A keypad 70 is based on a keypad of conventional telephones, and buttons are positioned behind the graphic elements of the individual keys and can be used to select the corresponding number or key.

Furthermore, the user interface has a display field 66 which is based on a display unit of a conventional telephone. The display field 66 has a display area 66a in which a call number is displayed which is the internal call number of the subscriber station in a CENTREX group to which the subscriber line of the terminal 32 belongs. Furthermore, the display field 66 has a display area 66b in which the subscriber's own subscriber line call number with which the subscriber station can be accessed via the public line-switched telephone network is displayed. The display field 66 can be used to display to the subscriber further information such as the call number of a calling subscriber or setting possibilities for controlling services and/or features. Further buttons of the illustrated key group 68 and of the further group of function keys 72 can be used to activate, deactivate and administer further operating functions and features. The functions of these keys are based on a real telephone. The abbreviated dialing keys 62a to 62i have display areas, only the display area 74i of the abbreviated dialing key 62i being designated. If, for example, the function for which the abbreviated dialing key is used is activated, the display area of this abbreviated dialing key is represented as red, for example. If a call is parked, the display area of the abbreviated dialing key 62b is then represented in a red color. If a connection to a subscriber whose call number can be called using an abbreviated dialing key is activated, the display area of this abbreviated dialing key is then represented as red during the connection. The areas 64a and 64b are used for the graphic representation of brand names, such as that of the manufacturer of the telephone represented and/or of the manufacturer of the software for representing the telephone.

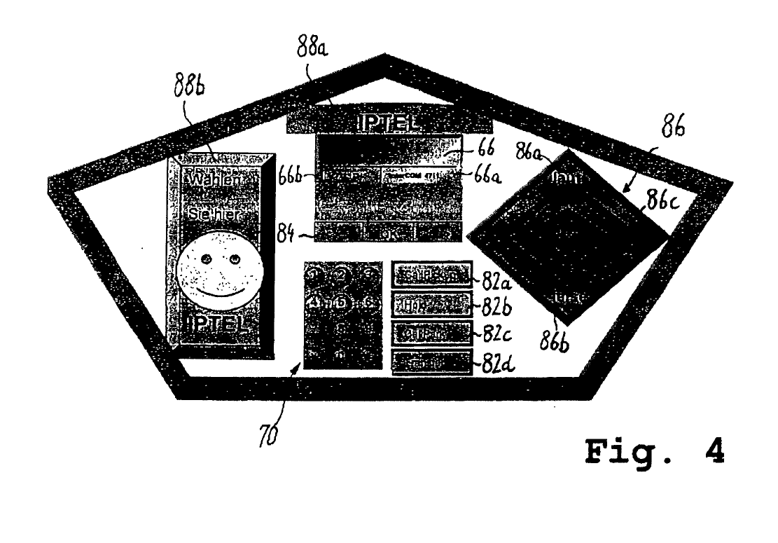

FIG. 4 illustrates a further possible graphic user interface 80 of the terminal 32. The graphic user interface 80 has, like the graphic user interface 60, a display field 66 with the display areas 66a and 66b. The functions of the display field 66 and of the display areas 66a, 66b have already been explained in the description relating to FIG. 3. The graphic user interface 80 has also, like the user interface 60 in FIG. 3, a keypad 70. Furthermore, function keys 82a to 82d are provided, the function key 82a serving to transfer calls, the function key 82b serving to hold calls, the function key 82c serving to park calls and the function key 82d serving to divert calls. Furthermore, a keypad 84 is provided which is used to control functions and features as well as configure setting possibilities of the terminal 32.

A display field 86 is used to display various setting options, with the volume setting option being displayed here. This display area has buttons positioned behind it, in the same way as the keypad 70, the function keys 82a to 82d and the keypad 84, and these buttons can be activated using a pointer apparatus, for example. In the display area 86, by using the pointer apparatus on the “loud” 86a button it is possible to increase the volume, and the volume can be reduced using the “quiet” 86b button. The speaker can be set to a mute setting using the button 86c. The areas 88a and 88b are used to represent advertising information, the display area 88b having positioned behind it a button whose activation causes a connection to be set up to a call number assigned to the button 88b. In this way, this advertising area 88b is also used as an abbreviated dialing key.

The graphic elements 66, 70, 82a to 82d, 84, 86, 88 can be arranged as desired on the graphic user interface by the user of the terminal. This can be done using, for example, a program module of the terminal 32 which is provided for this purpose. The user can move, or delete these graphic elements 66, 70, 82a to 82d, 84, 86, 88 on or from the screen, together with the buttons positioned behind the graphic elements 66, 70, 82a to 82d, 84, 86, 88, or add further operating elements and/or display elements using, for example, the pointer apparatus. The user can also change the graphic representation of individual graphic elements, for example the key block 70 or the abbreviated dialing keys 82a to 82d. The user can adapt the size of the individual graphic elements 66, 70, 82a to 82d, 84, 86, 88 as he desires. The size of the buttons positioned behind the graphic elements 66, 70, 82a to 82d, 84, 86, 88 is automatically adapted at the same time.

However, the terminal 32 does not need to be operated exclusively via a pointer apparatus. For example, the call number also can be input via the numerical keypad of the terminal 32. A touch-sensitive screen also may be provided as the display unit of the terminal 32, the individual buttons being activated by a user touching the surface of the screen. Such a touch sensitive screen is also referred to as a touchscreen. A computer, for example a personal computer, is preferably used as the terminal 32. However, other apparatuses, which are embodied, for example, as a special IP telephone, are also conceivable. In such apparatuses it is in particular possible to reduce the power drain in comparison with a personal computer. This apparatus also can be adapted in such a way that a user has the same degree of operating convenience when operating the apparatus as when operating a conventional telephone. For example, the keypad 70 and/or function keys 82a to 82d as well as further key groups and display fields may be embodied via hardware on the apparatus. A conventional telephone receiver also may be connected both to a computer used as an IP terminal and to a special IP telephone and can be used to play back and register the voice data. However, other input and output devices, for example a headset which is composed of an ear piece and a microphone connected to the ear piece, or a loudspeaker and a separate microphone, may be connected both to the personal computer and to the IP telephone.

However, a representation of a fax apparatus or of a telephone answering machine or a combined representation of these apparatuses with a telephone may be used as the user interface. The user is thus provided with further communication possibilities which can already be used with conventional communications apparatuses.

Although the present invention has been described with reference to specific embodiments, those of skill in the art will recognize that changes may be made thereto without departing from the spirit and scope of the invention as set forth in the hereafter appended claims.

1. A terminal of a packet-switching communications network, comprising a data processing system which includes a first program module for processing first signaling information of the packet-switching communications network, the first signaling information being defined in a first packet-switching standard protocol and being transmitted using signaling packets of the packet-switching communications network, and the first program module being designed to process second signaling information which is transmitted using data packets for the packet-switching communications network and which is defined according to a second standard protocol different from the first standard protocol.

2. A terminal of a packet-switching communications network as claimed in claim 1, wherein the second signaling information is signaling information of a line-switching communications network.

3. A terminal of a packet-switching network as claimed in claim 2, wherein the second signaling information is signaling information in accordance with a DSS1 signaling protocol.

4. A terminal of a packet-switching communications network as claimed in claim 1, wherein the first signaling information is signaling information with an H.323/H.450 signaling protocol.

5. A terminal of a packet-switching communications network as claimed in claim 1, wherein the data packets used to transmit the second signaling information are transmitted in a part of the signaling packets which does not contain any first signaling information.

6. A terminal of a packet-switching communications network as claimed in claim 1, wherein signaling information for at least one service or feature which cannot be used by the first signaling information is transmitted as second signaling information.

7. A terminal of a packet-switching communications network as claimed in claim 6, wherein the at least one service or feature includes at least one of a call pick up, three way conferencing, large scale conferencing, holding, displaying of toll information, a closed user group, call number identification, automatic call back when busy, automatic call back when no response, call barring, call waiting indication and call transfer.

8. A terminal of a packet-switching communications network as claimed in claim 1, wherein the second signaling information is transmitted from the terminal to a further terminal and is further transmitted from the further terminal to the terminal, using the packet-switching communications network in accordance with a tunnel principal.

9. A terminal of a packet-switching communications network as claimed in claim 8, wherein the second signaling information is transmitted from the terminal to an interface unit between the packet-switching communications network and a lines switching communications network, transmitted from the interface unit to the terminal, using the packet-switching communications network.

10. A terminal of a packet-switching communications network as claimed in claim 9, wherein the interface unit converts the signaling information of the line switching communications network into the first signaling information, the second signaling information including the signaling information of the line switching communications network which cannot be converted in first signaling network information.

11. A terminal of a packet-switching communications network as claimed in claim 1, wherein the data processing system contains a second program module which converts the transmitted signaling information into image information to be displayed on a display unit and processes information which is input using an input unit, data being exchanged between the first program module and the second program module.

12. A terminal of a packet-switching communications network as claimed in claim 11, wherein the first program module conditions the information acquired using the second program module in order to transmit the information to the packet-switching communications network.

13. A terminal of a packet-switching communications network as claimed in claim 12, wherein the data is exchanged between the first program module and the second program module using a program interface.

14. A terminal of a packet-switching communications network as claimed in claim 13, wherein at least one of the first signaling information and the second signaling information is stored in a data base of the data processing system.

15. A terminal of a packet-switching communications network as claimed in claim 1, wherein the second program module makes available a graphic user interface.

16. A terminal of a packet-switching communications network as claimed in claim 1, wherein the second signaling information is processed and generated by a third program module.

17. A terminal of a packet-switching communications network as claimed in claim 1, wherein the packet-switching communications network is a data network based on an internet protocol, and the terminal is an IP terminal.

18. A terminal of a packet-switching communications network as claimed in claim 1, wherein a voice connection to a further subscriber can be set up using the terminal.

19. A terminal of a packet-switching communications network as claimed in claim 1, wherein a second program module makes available a graphic user interface for inputting and outputting data.

20. A terminal of a packet-switching communications network as claimed in claim 19, wherein the data processing system includes a forth program module which can be used to process the graphic user data.

21. A terminal of a packet-switching communications network as claimed in claim 19, wherein a plurality of possible graphic user interfaces are stored in the data processing system, and the user interfaces can be switched over using the second program module.

22. A terminal of a packet-switching communications network as claimed in claim 19, wherein the information is input using buttons on the graphic user interface.

23. A terminal of a packet-switching communications network as claimed in claim 1, wherein the terminal is a computer system with hardware and software.

24. A method for operating telecommunications systems having a packet-switching communications network, the method comprising the steps of:
providing a terminal which is connected to the packet-switching communications network, the terminal containing a data processing system which includes a first program module;
processing, via the first program module, first signaling information of the packet-switching communications network;
defining the first signaling information in a first packet-switching standard protocol;
transmitting the first signaling information using signaling packets of the packet-switching communications network;
defining second signaling information according to a second standard protocol different from the first standard protocol;
transmitting the second signaling information using data packets of the packet-switching communications network; and
processing the second signaling information via the first program module.

25. A method for operating telecommunications systems having a packet-switching communications network as claimed in claim 24, wherein first signaling information is signaling information in accordance with an H.323/H.450 signaling protocol.

26. A method for operating telecommunications systems having a packet-switching communications network as claimed in claim 24, wherein the second signaling information is signaling information in accordance with a DSS1 signaling protocol.

27. A method for operating telecommunications systems having a packet-switching communications network as claimed in claim 24, wherein the packet-switching communications network is a data network based on an internet protocol
